(19) United States
(12) Patent Application Publication
(10) Pub. No.: US 2015/0154080 A1
(43) Pub. Date: Jun. 4, 2015

(54) Critical Memory Checkpointing for Downloadable OS

(71) Applicant: WMS Gaming Inc., Waukegan, IL (US)

(72) Inventors: Ranjan Dasgupta, Naperville, IL (US); Jorge Luis Shimabukuro, Las Vegas, NV (US)

(21) Appl. No.: 14/546,012

(22) Filed: Nov. 18, 2014

Related U.S. Application Data
(60) Provisional application No. 61/911,770, filed on Dec. 4, 2013.

(51) Int. Cl. G06F 11/14; G06F 9/445

(52) U.S. Cl. CPC G06F 11/1433; G06F 8/65; G06F 2201/865

(57) ABSTRACT

A selectively stored roll back data set is configured to facilitate (1) automatically rolling an electronic gaming machine (EGM) backward to a previous operating system (OS), (2) electively rolling back the EGM to a previous OS, and (3) cloning a state of the EGM to one or more other EGMs. In an embodiment, the roll back data set is collected from nonvolatile sources of the EGM. Each set may include machine configuration data and data structures associated with the current OS. When a change back to the original OS is needed or desired, e.g., due to an installation failure of a downloadable OS (DLOS), or when cloning is desired, the roll back data set is automatically retrieved and the EGM is reverted.

### CROSS-REFERENCE TO RELATED APPLICATION

This application claims the benefit of U.S. Provisional Application Ser. No. 61/911,770, filed Dec. 4, 2013. The patent application identified above is incorporated herein by reference in its entirety to provide continuity of disclosure.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE DISCLOSURE

The disclosure relates generally to wagering game machines and more particularly to upgrading and rolling back operating systems for wagering game machines.

### BACKGROUND OF THE DISCLOSURE

Wagering game machines have been entertaining people for more than a century. The first such machines, invented at the end of the 19th century for use in pubs, allowed pub patrons to spin a set of reels and occasionally win a prize such as a beer. In the years following the introduction of wagering game machines, the mechanical workings and configurations of such machines steadily evolved, providing more and more exciting payout options and more and more types of games.

As early as the 1940s, the first electromechanical wagering game machines began to compete with purely mechanical machines, and by the 1960s, electromechanical gaming machines were providing bottomless hoppers and automated payouts of up to 500 coins. Game design continued to march steadily forward, becoming more varied, automated, and computerized. By 1996, games such as the WMS REEL'EM IN game began providing a second screen bonus round wherein an entirely different game could be displayed, and an extra payout could be won. By this time, most wagering game machines had become fully electronic and computerized, and were increasingly referred to simply as electronic gaming machines (EGMs).

The computerization of gaming machines benefited patrons by providing for more interesting and varied games. Such machines also benefited casino operators by allowing them to more easily configure the machines, e.g., to modify odds, change games, add game features and so on. EGMs also simplified game accounting and machine repair, increasing the efficiency of casino operations.

Each computerized, i.e., processor-based, EGM utilizes an operating system (OS) to provide basic input/output services, memory services, and interface services, and to support various machine functions. However, in order to allow an EGM to work with new game generations or new generations of interfaces or peripheral hardware, an updated version of the OS is periodically required.

Traditionally, upgrading the OS in an EGM has been a time-consuming task, requiring manual intervention by a technician for each machine. However, the inventors have noted that the use of a downloadable OS greatly increases the ease and efficiency with which OS upgrades may be executed. Nonetheless, the versioning of objects during the upgrade to correspond to the new OS may still present complications. In particular, during installation of a new OS, it may be necessary to “version” certain objects, i.e., to modify them so that they function with the new operating system.

The new OS and associated installation software will generally be configured to recognize and modify existing object types to function within the new OS. However, the prior OS that is being replaced will typically not be configured to recognize and work with the newly versioned objects, since by definition the versioned objects are associated with a later OS. As such, once the objects are versioned, it is difficult to automatically rollback the EGM to the prior OS if the need arises. For example, the new OS installation may fail at one of multiple checkpoints, indicating a need to abandon the update and rollback the OS. With later versions of critical objects, this rollback is difficult.

While the disclosed principles address some or all of the shortcomings described above via various embodiments, it will be appreciated that the solution of any particular problem is not to be taken as a limitation of any of the claims herein unless explicitly stated. Moreover, this background section is provided as an educational aid to the reader, and is not intended to be precisely representative of prior art. Thus, the inventors expressly hereby note that the mention of any specific feature or aspect in the foregoing is not intended to be an indication that the feature or aspect is representative of actual prior art.

### SUMMARY OF THE DISCLOSURE

In an embodiment of the disclosed principles, a method is provided to install a second OS on an EGM already having a first OS installed. The method includes automatically collecting, from one or more nonvolatile sources associated with the EGM, a roll back data set comprising machine configuration data and one or more data structures associated with the first OS. The collected roll back data set is stored in a nonvolatile storage location associated with the EGM. At some point the second OS is downloaded to the EGM over a network connection between the EGM and a server and installation of the second OS is initiated. However, it is subsequently determined to roll the EGM back to the first OS, resulting in retrieval of the stored roll back data set without human intervention and automatically reverting the EGM to run the first OS based on the roll back data set.

In another embodiment, an EGM is provided that is able to automatically change from using a first OS to using a second OS. The EGM includes one or more nonvolatile data sources associated with the EGM and a network interface from the EGM to an OS server. In this embodiment, a processor associated with computer-executable instructions causes the collection of a roll back data set from the one or more nonvolatile data sources, including machine configuration data and one or more data structures associated with the first OS, and the storage of the collected roll back data set in a nonvolatile memory location associated with the EGM. The processor also downloads the second OS at the EGM from the OS server and initiates installation of the second OS. Based on an event or occurrence, the processor determines to roll the EGM back to the first OS using the roll back data set.

In yet another aspect of the disclosed principles, a method is provided for implementing a configuration on a first EGM having an existing configuration. In keeping with this embodiment, the first EGM receives a roll back data set from a second EGM, the roll back data set comprising machine configuration data of the second EGM. The first EGM is then automatically reconfigured in accordance with the configuration data of the second EGM.

### BRIEF DESCRIPTION OF THE DRAWINGS

FIG. 1 is a block diagram of an architecture, including a control system, for an EGM according to an example embodiment;

FIG. 2 is a block diagram of a software architecture for an EGM according to an example embodiment;

FIG. 3 is a block diagram of a networked system of EGMs and servers according to example embodiments;

FIG. 4 is a flowchart illustrating a process of creating a roll back data set according to example embodiments of the disclosed principles;

FIG. 5 is a flowchart illustrating methods for rolling back an OS of an EGM using a roll back data set according to example embodiments of the disclosed principles; and

FIG. 6 is a perspective view of a wagering game machine, according to example embodiments of the disclosed principles.

While the present disclosure is susceptible to various modifications and alternative forms, specific embodiments have been shown by way of example in the drawings and will be described in detail herein. It should be understood, however, that the present disclosure is not intended to be limited to the particular forms disclosed. Rather, the present disclosure is to cover all modifications, equivalents, and alternatives falling within the spirit and scope of the appended claims.

### DETAILED DESCRIPTION

Reference will now be made in detail to specific embodiments or features, examples of which are illustrated in the accompanying drawings. Generally, corresponding reference numbers will be used throughout the drawings to refer to the same or corresponding parts. While the present disclosure may be embodied in many different forms, the embodiments set forth in the present disclosure are to be considered as exemplifications of the principles of the present disclosure and are not intended to be limited to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

In the following detailed description of exemplary embodiments of the disclosed principles, reference is made to the accompanying drawings which form a part hereof, and in which is shown by way of illustration specific exemplary embodiments in which the disclosed principles may be practiced. These embodiments are described in sufficient detail to enable those skilled in the art to practice the disclosed principles, and it is to be understood that other embodiments may be utilized and that logical, mechanical, electrical and other changes may be made without departing from the scope of applicability of the disclosed principles.

Some portions of the detailed descriptions which follow are presented in terms of algorithms and symbolic representations of operations on data bits within a computer memory. These algorithmic descriptions and representations represent the manner in which those skilled in the data processing arts convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computerized (processor-based) system that manipulates and transforms data represented as physical (e.g., electronic) quantities within the system's registers and memories into other data similarly represented as physical quantities within the system memories or registers or other such information storage, transmission or display devices.

In general, the examples described herein illustrate steps, structures and methodologies for updating an EGM OS in a manner that allows for automatic OS rollback on the EGM in the event of a failure during download or installation of the new OS. In addition to thus allowing automatic OS installation, e.g., in the context of a downloadable OS, various embodiments of the described principles provide additional features such as cloning of an EGM using checkpoints from another EGM, reverting an EGM to an earlier state, and ensuring the integrity of check-pointed states/critical memory files/data. In general terms, the described principles provide in at least some embodiments, for the installation of or switching to a different OS version, whether to a newer or older version, without the need for explicit reconfiguration of critical data. Even when the second OS is an older OS, it may still be activated if a rollback data set exists for this older OS. Such a data set may have been created pursuant to a prior elective rollback in cases where the older OS has been used previously by the EGM in question. In keeping with the foregoing overview, the disclosed systems and methodologies will be described in greater detail below.

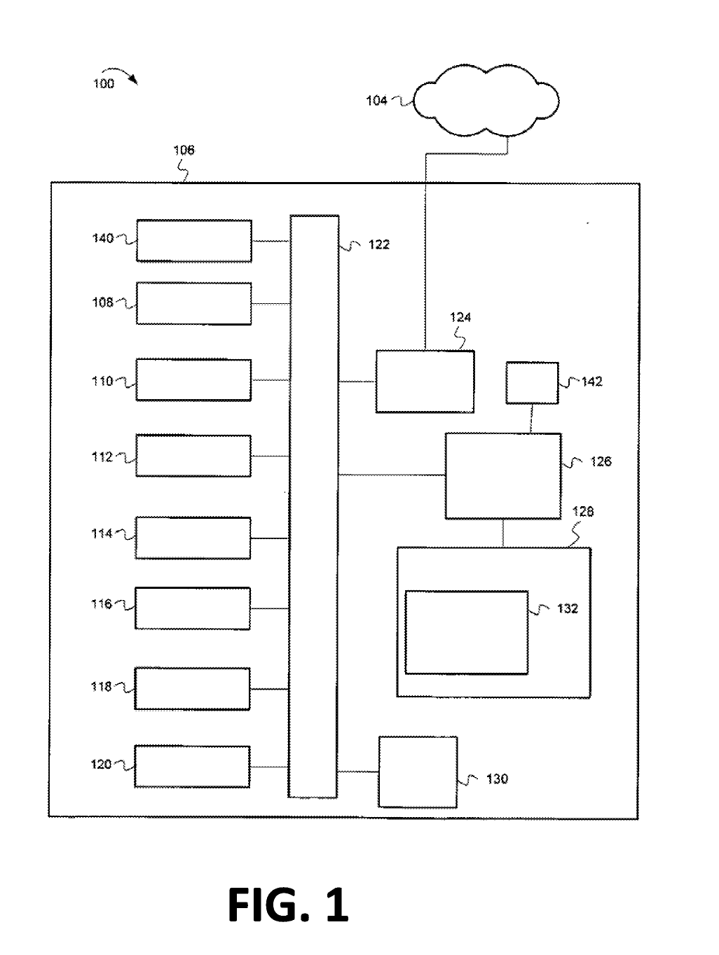

Turning now to the figures, FIG. 1 is a block diagram illustrating an EGM architecture 100, within which embodiments of the disclosed principles may be implemented. As illustrated, the EGM 106 has game logic circuitry that includes a central processing unit (processor) 126 connected to main memory 128, which may store wagering game software 132. Game logic circuitry, as used herein, comprises any combination of hardware, software, or firmware disposed in or outside of the EGM 106 that is configured to communicate with or control the transfer of data between the EGM 106 and a bus, another computer, processor, device, service, or network. The game logic circuitry, and specifically the CPU 126, comprises one or more controllers or processors and such one or more controllers or processors need not be disposed proximal to one another and may be located in different devices or in different locations. The game logic circuitry, and more specifically the main memory 128, comprises one or more memory devices which need not be disposed proximal to one another and may be located in different devices or in different locations. The game-logic circuitry is operable to execute all of the various gaming methods and other processes disclosed herein. In an embodiment, the wagering game software includes software associated with presenting wagering games, such as video poker, video black jack, video slots, video lottery, etc., in whole or part. The wagering game software 132 may also provide for bonus rounds, themes, advertising content, attract mode content, pay tables, denomination tables, audio files, video files, operating system files and other software associated with a game or the operation of the EGM.

The game logic circuitry, and specifically the processor 126, is also connected to an input/output (I/O) bus 122, which facilitates communication between the EGM's components. The I/O bus 122 may be connected to a payout mechanism 108, primary display 110, secondary display 112, value input device 114, player input device 116, information reader 118, and/or storage unit 130. The player input device 116 can include the value input device 114 to the extent the player input device 116 is used to place wagers.

The EGM 106 optionally communicates with one or more external systems 104 (e.g., wagering game networks) via the I/O bus 122 and an external system interface 124, such that the EGM 106 operates as a thin, thick, or intermediate client. The game-logic circuitry—whether located within (“thick client”), external to (“thin client”), or distributed both within and external to (“intermediate client”) the EGM 106—is utilized to provide a wagering game on the EGM 106. In general, the main memory 128 stores programming for a random number generator (RNG), game-outcome logic, and game assets (e.g., art, sound, etc.)—all of which obtained regulatory approval from a gaming control board or commission and are verified by a trusted authentication program in the main memory 128 prior to game execution. The authentication program generates a live authentication code (e.g., digital signature or hash) from the memory contents and compares it to a trusted code stored in the main memory 128. If the codes match, authentication is deemed a success and the game is permitted to execute. If, however, the codes do not match, authentication is deemed a failure that must be corrected prior to game execution. Without this predictable and repeatable authentication, the EGM 106, external system 104, or both are not allowed to perform or execute the RNG programming or game-outcome logic in a regulatory-approved manner and are therefore unacceptable for commercial use.

When a wagering-game instance is executed, the CPU 126 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 126 when executing the game-outcome logic to determine a resultant outcome for that instance of the wagering game. The resultant outcome is then presented to a player of the EGM 106 by accessing the associated game assets, required for the resultant outcome, from the main memory 128. The CPU 126 causes the game assets to be presented to the player as outputs from the EGM 106 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player, for example, at a minimum of 100 Hz (100 calls per second) as set forth in Nevada's New Gaming Device Submission Package. Accordingly, the RNG cannot be carried out manually by a human.

The gaming machine 10 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

Storage unit 130 may be any type of device configured to persistently store data. Examples of such devices include but are not limited to hard drives, DVD drives, flash memory, compact flash memory, various types of NVRAM (Non-volatile RAM), and so on. Among its other uses, the storage unit 130 may be used to store wagering game software, OS code, BIOS code, and so on.

In some embodiments, the EGM 106 may include backplane memory 140 and an SPI (Serial Peripheral Interface) 142. The backplane memory 140 may include memory that stores a serial number for the system, meter data for the system, and may include other types of specialized data for the system. The SPI 142 in some embodiments provides an interface to memory used to store data such as jurisdictional data that may be used to provide identification regarding the regulatory jurisdiction for the EGM 106 and other jurisdictional dependent data. The memory may also store bet limit and/or win limit data.

Wagering game software 132 may be loaded from storage unit 130, or it may be loaded from external systems 104 such as servers or other systems on a wagering game network. In general, wagering game software 132 comprises modules or units that operate to present one or more wagering games upon which monetary value may be wagered.

Some embodiments of the disclosed principles include an audio subsystem 120. Audio subsystem 120 provides audio capabilities to the EGM 106 and may comprise an audio amplifier coupled to speakers or an audio jack, and may further include an audio programming source on a memory such as a CD, DVD, flash memory etc.

In one embodiment, the wagering game machine 106 can include additional peripheral devices and/or more than one of each component shown in FIG. 1. For example, the peripherals may include a bill validator, a printer, a coin hopper, a button panel, or any of the many peripherals now found in EGMs (or included in EGMs in the future). Further, in some embodiments, the EGM 106 can include multiple external system interfaces 124 and multiple processors 126. In an embodiment, one or more of the illustrated components are integrated or subdivided. In another embodiment, one or more of the distinctly illustrated components of the EGM 106 are interconnected according to any suitable interconnection architecture.

It will be appreciated that any of the active components of the EGM 106 may be implemented via hardware, firmware, and/or software for performing the operations described herein. Machine-readable media includes any mechanism that provides (i.e., stores and/or transmits) information in a form readable by a machine (e.g., a wagering game machine, computer, etc.). For example, tangible (nontransitory) machine-readable media includes read only memory (ROM), random access memory (RAM), magnetic disk storage media, optical storage media, flash memory machines, etc. The term machine-readable media more generally also includes any media suitable for transmitting software over a network.

In operation, a player uses the EGM 106 to play of a wagering game. Using the available input mechanisms such as value input device 114 or devices coupled through player input device 116, the player selects any variables associated with the wagering game and place his/her wager to purchase a play of the game. In a play of the game, the processor 126 generates or receives at least one random event and provides an award to the player upon a winning outcome of the random event. The processor 126 operates the displays 110 and 112 to represent the random event(s) and outcome(s) in a visual form that can be understood by the player. In some embodiments, a wagering game segment may be triggered based on certain events. For example, a bonus round may be triggered.

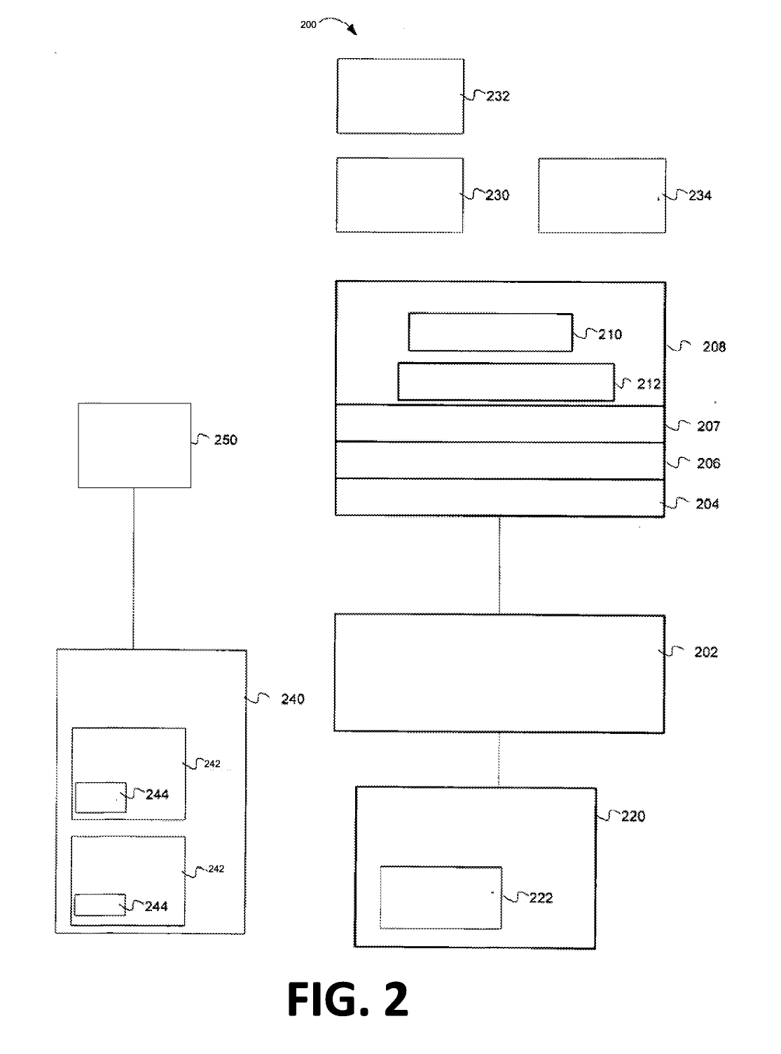

Looking more specifically at the logical arrangement and operation of the EGM 106, FIG. 2 shows a schematic diagram of an exemplary logical architecture 200 implemented on the EGM 106 according to an embodiment of the disclosed principles. As shown in FIG. 2, the exemplary architecture 200 includes a hardware platform 202, a boot program 204, a system services layer 207, and a game framework 208 that includes one or more wagering game software components 210 and/or game services 212. Importantly, the architecture 200 includes an operating system 206.

The boot program 204 may include a basic input/output system (BIOS) or other initialization program that works in conjunction with the operating system 206 to provide a software interface to the hardware platform 202. As noted above, the hardware platform 202 may be coupled to one or more peripherals 220, including the peripherals described above with reference to FIG. 1. One or more of the peripherals 220 may utilize firmware 222 to control the operation of the peripheral. For example a ticket printer may use firmware to control how tickets are printed in response to print data sent by a wagering game.

System services layer 207 may include device drivers that provide an interface between wagering game framework 208 and the devices present on a wagering game machine. Further, system services layer 207 may include services such as database services, network related services or other generalized services available within the architecture. The game framework 208 may include software components that are designed for a particular wagering game. Game services 212 may include services that are used to support the operation of a wagering game or the EGM 106.

In operation, a roll back data recorder 250 creates a roll back data set 242, which is an authenticated copy of the states of selected non-volatile EGM memory for the existing DLOS version. Nonlimiting examples of such data include backplane EPROM contents, any structures stored in NVRAM, and similar persistent data on the EGM hard drive, which may provide overflow space for the NVRAM. Nonlimiting examples of specific data and data structures from within these locations include configuration information (e.g., denomination configuration, coin limit, bill validator values, ticket printer data, external protocols, e.g., G2S, and so on). In addition, game configuration data, system configuration data, image data, and lifetime meter etc. may be stored in the roll back data set 242. Although no data or data structure need be omitted from the roll back data set 242, examples of data that might be omitted from the roll back data set 242 in a given implementation include event logs, error logs, meter information (e.g., for game and system meters). Similarly, information related to a specific instance of game play need not be, but may be, stored in the roll back data set 242 since a user is typically not playing a game when a DLOS installation is attempted.

Non-volatile state information on an EGM is typically stored in one or more hardware devices such as non-volatile RAM (NVRAM), a hard disk drive (HDD), a solid state drive (SSD), an electrically erasable programmable read only memory (EEPROM) or other non-volatile memory device. In an embodiment, the roll back data set 242 is stored in a non-volatile memory location such as a dedicated storage location or device 240. Possible specific storage locations include a storage unit, e.g., shown as storage 130 of FIG. 1, a hard drive partition, and a network attached storage device such as a server. While the roll back data set 242 is illustrated as a single unitary entity, it will be appreciated that the roll back data set 242 may be stored in separate components, e.g., as linked objects or data structures, and may be stored on a plurality of storage devices rather than a single such device if desired.

In an embodiment, the roll back data set 242 includes an OS version identifier 244 that identifies the specific OS version associated with the roll back data set 242. It will be appreciated that multiple roll back data sets 242 may be stored for a single OS version. For example, it may be desired that the system be able to selectively roll back to one of several states depending upon the nature of the problem encountered during installation or registration of the new OS. To accommodate the possibility of multiple roll back points for a given OS version, multiple roll back data sets 242 may be serialized via a serial or ID number, which may be stored with the OS version identifier 244 or may be stored separately. Such multiple roll back data sets 242 may be created upon the occurrence of one or more specified events such as an upgrade of one or more components or modules, or may be created according to a periodic or aperiodic schedule.

In more general terms, the data generated during the operation of the EGM typically includes at least meter data 230 and log data 232. Meter data 230 represents data associated with metering certain quantities during game play, e.g., current credit values, win amount values, coin-in values, amount bet and other data regarding the state of the EGM. In contrast, log data 232 includes data relating to past events of interest that have occurred on the EGM such as error events, win events, jackpot events, machine restarts, software loads etc. As noted above, a game will not be in progress when an OS change is initiated. As such, meter data 230 need not be, but may be, stored. However, although it is possible to omit log data 232 in an embodiment, log data 232 is preferably included in the roll back data set 242.

Certain configuration data 234 may be stored with the roll back data set 242. This may include data that determines which events generate creation of a roll back data set 242 and/or the intervals at which roll back data sets 242 are stored. Further, the configuration data 234 may include data that determines which data structures are included in the roll back data set 242.

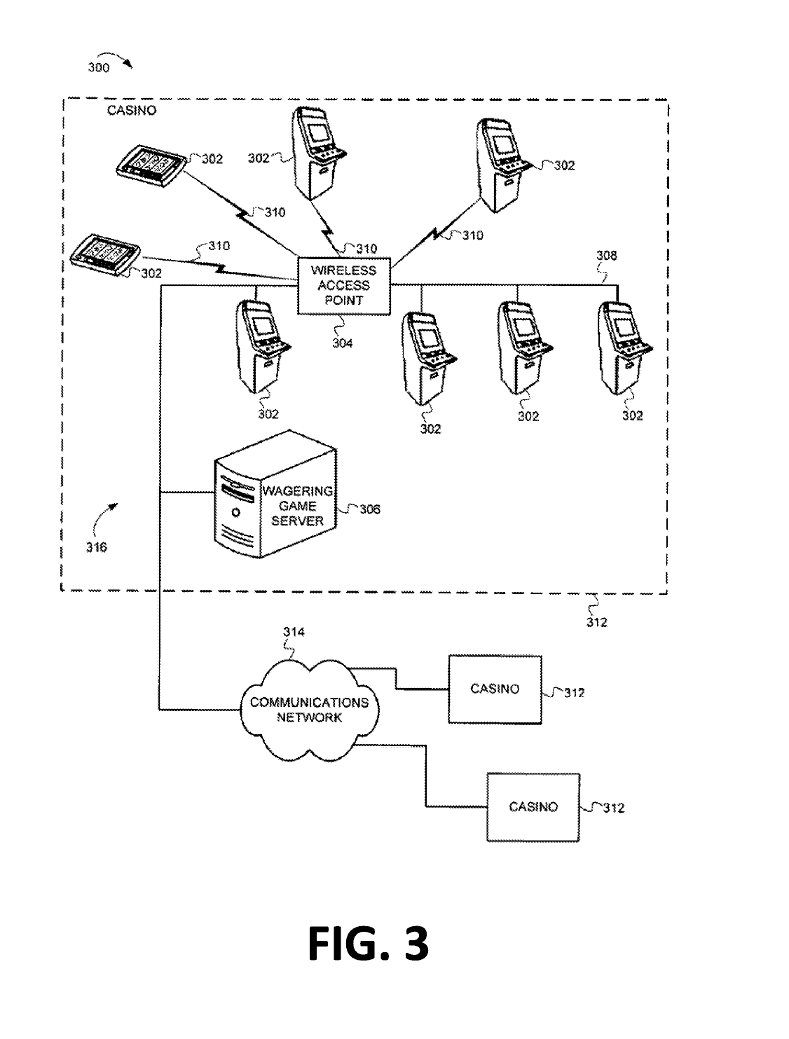

As noted above, in some embodiments of the described principles, cloning of a specific EGM is enabled using a roll back data set 242 from another EGM. The data transfer required for cloning may be executed by the transfer of removable media or via networking between machines and/or between one or more EGMs and a server. With respect to the linking of machines, multiple EGMs may be linked via an EGM network, e.g., within a particular casino having such machines. The schematic illustration of FIG. 3 shows the manner in which a plurality of EGMs may be interconnected via an EGM network.

The illustrated network 300 includes a plurality of casinos 312 or other gaming establishments connected to a communications network 314. Each of the plurality of casinos 312 includes a local area network 316, which may include a wireless access point 304, EGMs 302, and a game server 306 that can serve games over the local area network 316. As such, the local area network 316 includes wireless communication links 310 and wired communication links 308. The wired and wireless communication links can employ any suitable connection technology, such as Bluetooth, 802.11, Ethernet, public switched telephone networks, SONET, etc. In one embodiment, the game server 306 may serve games and/or distribute content to devices located in other casinos 312 or at other locations on the communications network 314.

As noted above, the EGMs 302 and game server 306 may include hardware and machine-readable media including instructions for performing operations described herein. The EGMs 302 can take any suitable form, such as floor standing models, handheld mobile units, bar top models, workstation-type console models, etc. Further, the EGMs 302 may be primarily dedicated for use in conducting wagering games, or can include non-dedicated devices, such as mobile phones, personal digital assistants, personal computers, etc. In one embodiment, the wagering game network 300 can include other network devices, such as accounting servers, wide area progressive servers, player tracking servers, and/or other devices suitable for use in connection with embodiments of the disclosed principles.

In some embodiments, the wireless access point 304 is a part of a communication station, such as wireless local area network (WLAN) communication station including a Wireless Fidelity (WiFi) communication station, or a WLAN access point (AP). In these embodiments, the EGMs 302 may be part of a mobile station, such as WLAN mobile station or a WiFi mobile station.

Alternatively, the wireless access point 304 can be part of a broadband wireless access (BWA) network communication station, such as a Worldwide Interoperability for Microwave Access (WiMax) communication station, as the wireless access point 304 can be part of almost any wireless communication device. In such embodiments, the EGMs 302 can be part of a BWA network communication station, such as a WiMax communication station.

It will be appreciated that any of the EGMs 302 can part of a portable wireless communication device, such as a personal digital assistant (PDA), a laptop or portable computer with wireless communication capability, a web tablet, a wireless telephone, a wireless headset, a pager, an instant messaging device, a digital camera, a television, or other device that can receive and/or transmit information wirelessly.

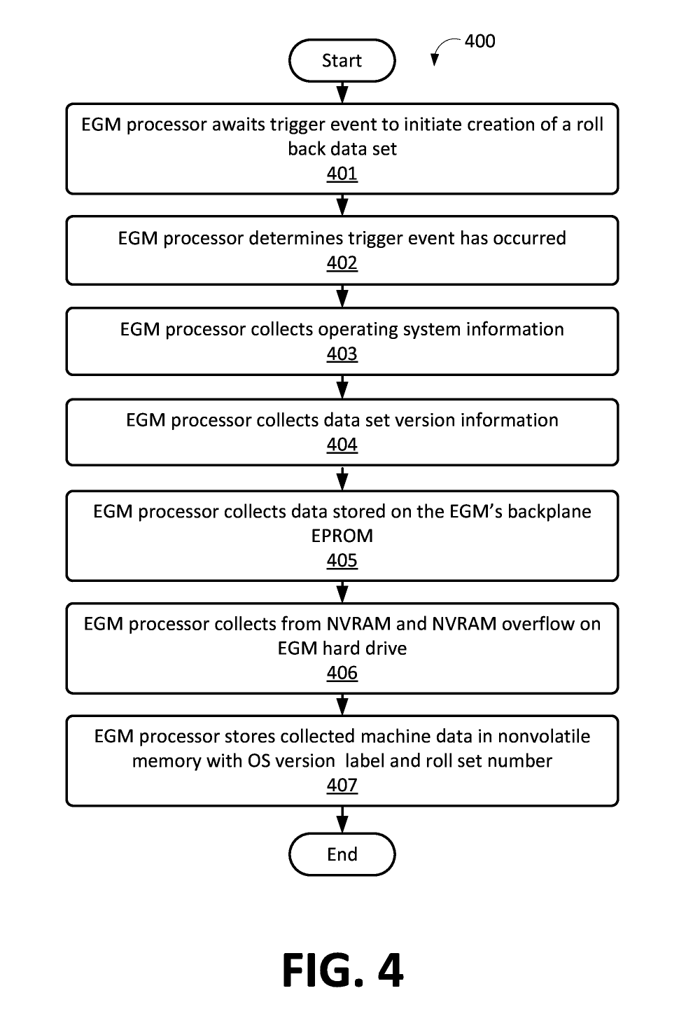

In keeping with the foregoing, FIG. 4 is a flowchart illustrating an exemplary process 400 for maintaining a current roll back data set 242 for an EGM. The methods to be performed by an operating environment such as control system 100, software architecture 200, and network system 300 constitute computer programs made up of computer-executable instructions stored on a non-transitory computer-readable medium.

The process 400 will be described by reference to acts performed by the EGM processor, but it will be appreciated that other processing components within or linked to the EGM may be used instead to perform some or all such acts. The EGM is assumed to be booted and stable before the process 400 begins. With that assumption met, the process 400 begins at stage 401, wherein the EGM processor awaits a trigger event that would initiate the creation of a roll back data set.

As noted above, the trigger event may be a randomly generated trigger signal, a periodic trigger signal (e.g., on an hourly, daily, weekly or other periodic basis), or an event-based trigger signal, e.g., generated when a change is detected in one or more classes of data structures that are needed to create roll back data sets. Such a change could occur pursuant to a hardware change, a software change, or an EGM configuration change, for example.

At stage 402, the processor determines, pursuant to the execution of computer-readable instructions as noted above, that a trigger event has occurred such that a roll back data set should be generated. Upon the occurrence of trigger event, the processor creates a roll back data set. In particular, in the illustrated example, the processor collects operating system information at stage 403, e.g., data sufficient to identify the currently running OS. At stage 404, the processor collects data set version information, e.g., by determining how many, if any, roll back data sets have been stored for the current OS. The processor then begins the collection of roll back data at stage 405 by collecting any data stored on the EGM's backplane EPROM. At stage 406, the processor collects any structures stored in NVRAM, and any persistent data on the EGM hard drive that is overflow data from the NVRAM.

As noted above, specific data and data structures from within these locations include configuration information (e.g., denomination configuration, coin limit, bill validator values, ticket printer data, external protocols, e.g., G2S, and so on). In addition, such data may include game configuration data, system configuration data, image data, and lifetime meter data. In general, information related to a specific instance of game play is not stored in the roll back data set 242.

At stage 407, the collected machine data is stored in nonvolatile memory along with a label or indicator specifying the OS version and roll back data set number, e.g., one greater than the detected number of existing roll back data sets for the same OS. In addition, the system may generate a log entry to indicate the time that the roll back data set was stored. In an optional embodiment, the roll back data set is stored as a delta referenced to one or more prior sets. For example, if there is no change from one set to the next, the roll back data set may indicate that fact via a single digit or character. Similarly, if some structures have changed and others have not, the roll back data set may include replacement data structures for the changed structures and with nothing, or only short symbolic entries, for unchanged structures.

In an embodiment, the integrity of the states/critical memory files/data of each roll back data set are checked, e.g., via a trusted platform module (TPM). In a further embodiment, each roll back data set, once checked, is signed to ensure validity.

As noted above, one goal of storing and tracking roll back data sets is to allow a roll back from a later OS to an earlier one in the event of a failure during downloading or installation of the later OS. For example, the later OS may download without a problem but may not pass checks after installation. At this point, the EGM processor reverts the machine to its prior OS and restores the associated data structures and configuration values.

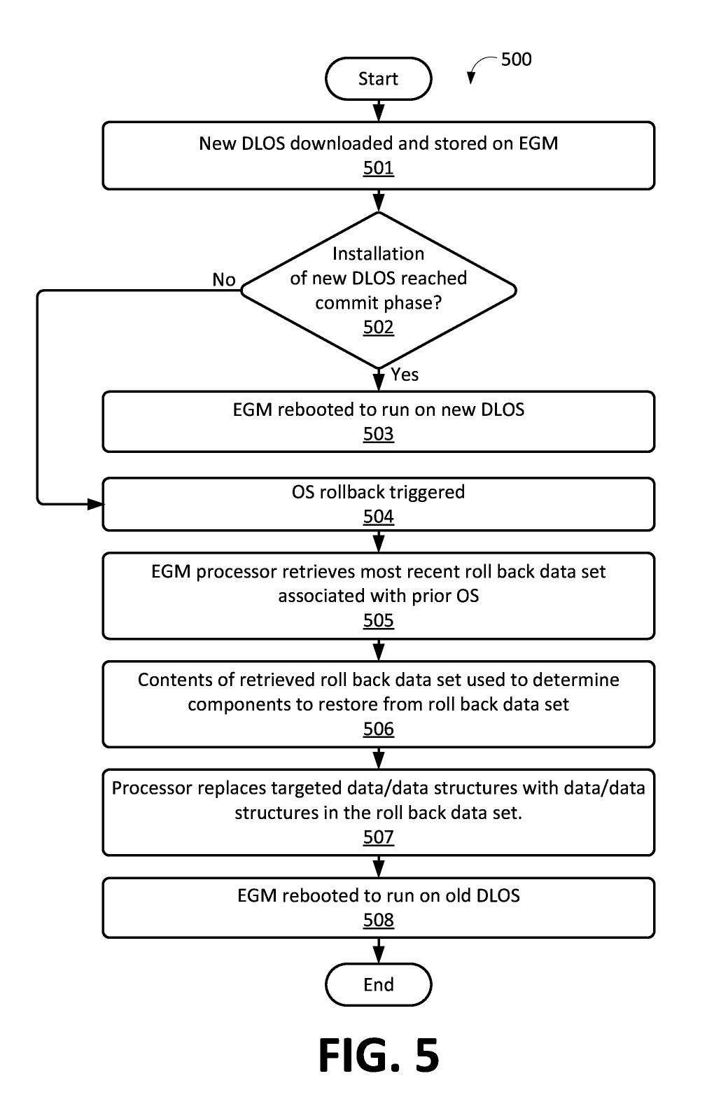

To facilitate discussion of the foregoing restoration process in greater detail, FIG. 5 is a flowchart illustrating an example process 500 for rolling an EGM back to a previously installed OS. This roll back results in the EGM operating via the prior OS as if the later OS had never been installed. In the illustrated example, it is assumed that an installation of a later OS on the EGM has not yet been accomplished or attempted.

Thus at stage 501 of the process 500, a new DLOS is downloaded and stored on a permanent storage device on the EGM. A roll back data set recording the state of all non-volatile objects of the previously running OS may be created prior to transitioning to the new OS. During installation of the new OS, it is possible for the EGM to experience an un-recoverable error condition. To handle such possibilities, installation of a DLOS incorporates a commit phase in an embodiment. Once the commit phase is reached, the installation is deemed to be a success. However, if the EGM faults before this phase is reached, it may be assumed that the DLOS install encountered an un-recoverable error. Thus, at stage 502, the EGM determines if installation of the new DLOS has reached the commit phase prior to the expiration of a timeout or the occurrence of an error. If the installation has reached the commit phase, then the process 500 flows to stage 503, wherein the EGM is rebooted to run on the new DLOS. As the EGM is upgraded to run newer versions of the OS, all versioned non-volatile objects are also upgraded via an object versioning mechanism to their corresponding version in the new OS. The roll back data set created for a given OS version will have versioned objects for that OS version.

If instead the installation of the new DLOS has not successfully reached the commit phase, then at stage 504, an OS roll back is triggered. At stage 505, the EGM processor retrieves the most recently stored roll back data set associated with the prior OS. Alternatively, an even earlier roll back data set may be automatically or manually selected, e.g., if the EGM was already exhibiting incorrect behavior at the time of the most recently stored roll back data set. In any event, the contents of the retrieved roll back data set are used by the processor at stage 506 to determine which components are to be rolled back, i.e. restored from the retrieved roll back data set. At stage 507, the processor deletes the targeted data and data structures and replaces them with the data and data structures held in the retrieved roll back data set. The EGM is then rebooted at stage 508 to run on the old DLOS.

It was discussed above that the disclosed principles may be used to clone the OS and configuration of a specific EGM to one or more other EGMs. In particular, it will be appreciated that the storage of non-volatile objects in a roll back data set can also be used to effectively clone one or more EGMs from a “model” EGM that has been setup with a desired configuration. A cloning operation may be initiated from the model EGM and pushed out to target EGMs, or may be initiated as a pull operation from a target EGM to the model EGM. In either case, the roll back data will be transferred from a model to a target EGM and used on the target EGM to re-program its non-volatile objects. Depending on the specifics of the implementation, a reboot may be required to bring the cloned state into operation.

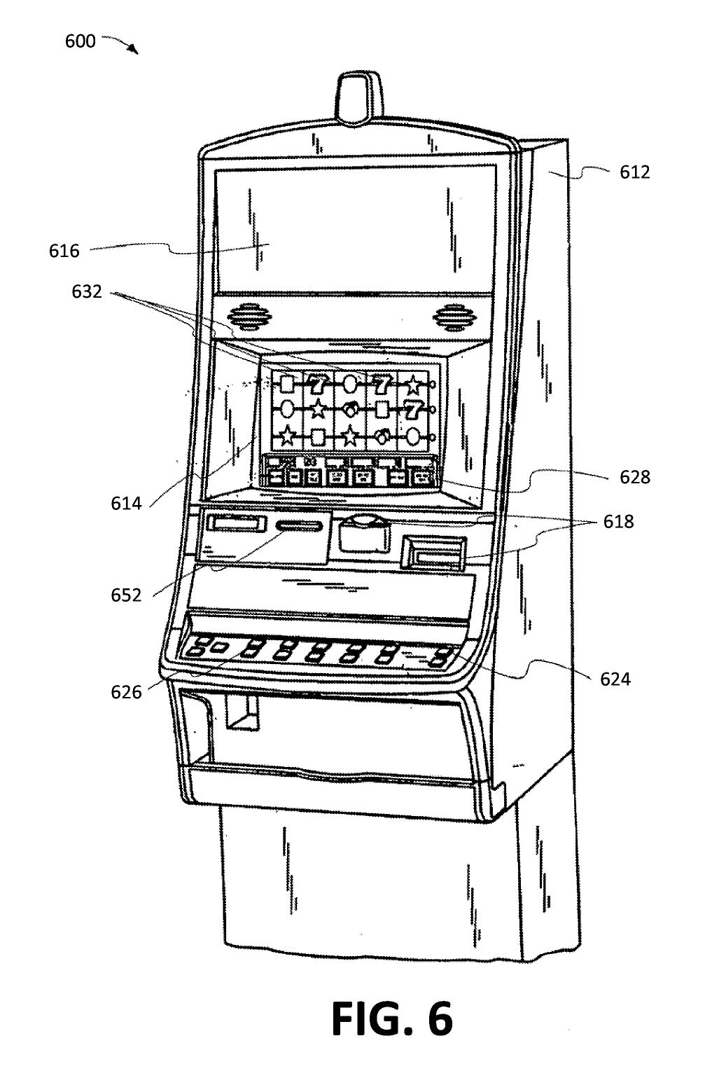

FIG. 6 is a perspective view of an example EGM 600, within which embodiments of the disclosed principles may be implemented. The EGM 600 may be similar to those operated in gaming establishments, such as casinos. With regard to the present disclosure, the EGM 600 may be any type of gaming terminal or machine and may have varying structures and methods of operation. For example, in some aspects, the EGM 600 is an electromechanical gaming terminal configured to play mechanical slots, whereas in other aspects, the gaming machine is an electronic gaming terminal configured to play a video casino game, such as slots, keno, poker, blackjack, roulette, craps, etc. The EGM 600 may take any suitable form, such as floor-standing models as shown, handheld mobile units, bartop models, workstation-type console models, etc. Further, the EGM 600 may be primarily dedicated for use in playing wagering games, or may include non-dedicated devices, such as mobile phones, personal digital assistants, personal computers, etc. Exemplary types of gaming machines are disclosed in U.S. Pat. Nos. 6,517,433, 8,057,303, and 8,226,459, which are incorporated herein by reference in their entireties

The EGM 600 illustrated in FIG. 6 comprises a gaming cabinet 612 that securely houses various input devices, output devices, input/output devices, internal electronic/electromechanical components, and wiring. The cabinet 612 includes exterior walls, interior walls and shelves for mounting the internal components and managing the wiring, and one or more front doors that are locked and require a physical or electronic key to gain access to the interior compartment of the cabinet 612 behind the locked door.

The input devices, output devices, and input/output devices are disposed on, and securely coupled to, the cabinet 612. By way of example, the input devices may include value input devices 618 and a player input device 624. For output, the EGM 600 includes a primary display 614 and an optional secondary display 616. The displays variously display information associated with wagering games, non-wagering games, community games, progressives, advertisements, services, premium entertainment, text messaging, emails, alerts, announcements, broadcast information, subscription information, etc. appropriate to the particular mode(s) of operation of the EGM 600. While some components of the EGM 600 are described herein, numerous other elements can exist and can be used in any number or combination to create varying forms of the EGM 600.

The value input devices 618 can take any suitable form and can be located on the front of the cabinet 612. The value input devices 618 can receive currency and/or credits inserted by a player. The value input devices 618 can include coin acceptors for receiving coin currency and bill acceptors for receiving paper currency. Furthermore, the value input devices 618 can include ticket readers or barcode scanners for reading information stored on vouchers, cards, or other tangible portable storage devices. The vouchers or cards can authorize access to central accounts, which can transfer money to the EGM 600.

The player input device 624 comprises a plurality of push buttons on a button panel 626 for operating the EGM 600. In addition, or alternatively, the player input device 624 can comprise a touch screen 628 mounted over the primary display 614 and/or secondary display 616. Components of the EGM 600 can be connected directly to, or contained within, the cabinet 612 or located outside of the cabinet 612 and being communicatively coupled with the EGM 600 using wired or wireless communication technology. The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

In some embodiments, the EGM 600 includes an information reader 652, which can include a card reader, ticket reader, bar code scanner, RFID transceiver, or computer readable storage medium interface. In some embodiments, the information reader 652 is used to award complimentary services, restore game assets, track player habits, etc.

The disclosed principles have been discussed with respect to implementing an automatic roll back, e.g., upon failure of a DLOS installation. However, these principles may also be used to effectuate an elective roll back of the OS to a previously installed OS. In an embodiment, an administrator accesses the EGM via the server side of G2S, which presents a list of images for each EGM.

Via this interface or another suitable interface, the administrator may elect to roll back the EGM to a prior OS. This action may use both the current state of the EGM as well as one or more roll back data sets (the current state of the EGM may be needed, for example, to maintain certain meters for regulatory purposes). It is possible to combine states from different roll back data sets as long as any versioned objects are combined in a manner that is compatible with the OS being restored.

Systems and methods for restoring an EGM to a prior or different OS and/or configuration have been disclosed herein. Although specific embodiments have been illustrated and described, it will be appreciated by those of ordinary skill in the art that any arrangement which is calculated to achieve the same purpose may be substituted for the specific embodiments shown. For example, although stages 505-507 are illustrated in FIG. 5 as occurring prior to reboot of the EGM, it will be appreciated that these stages may alternatively be executed during or after reboot without departing from the disclosed principles. This application is intended to cover any adaptations or variations of the inventive subject matter.

The terminology used in this application is meant to include all of these environments. It is to be understood that the above description is intended to be illustrative, and not restrictive. Many other embodiments will be apparent to those of skill in the art upon reviewing the above description. Therefore, it is manifestly intended that this disclosed principles be limited only by the following claims and equivalents thereof.

Each of these embodiments and obvious variations thereof is contemplated as falling within the spirit and scope of the present disclosure as defined and set forth in the following claims. Moreover, the present concepts expressly include any and all combinations and subcombinations of the preceding elements and aspects.

What is claimed:

1. A method of installing a second operating system (OS) on an electronic gaming machine (EGM) already having a first OS installed, the method comprising:
automatically collecting via a processor from one or more nonvolatile sources associated with the EGM, a roll back data set associated with the first OS, and storing the collected roll back data set in a nonvolatile storage location associated with the EGM, the roll back data set comprising machine configuration data and one or more data structures;
downloading the second OS to the EGM over a network connection between the EGM and a server;
initiating installation of the second OS by the processor;
determining by the processor to roll the EGM back to the first OS;
automatically retrieving the stored roll back data set by the processor; and
automatically reverting the EGM to run the first OS based on the roll back data set.

2. The method in accordance with claim 1, wherein determining to roll the EGM back to the first OS includes the processor detecting an error during installation of the second OS.

3. The method in accordance with claim 1, wherein determining to roll the EGM back to the first OS includes the processor receiving a request to roll the EGM back to the first OS.

4. The method in accordance with claim 1, wherein the second OS is a subsequent version of the first OS.

5. The method in accordance with claim 1, wherein the second OS is a prior version of the first OS.

6. The method in accordance with claim 1, wherein automatically collecting the roll back data set comprises collecting the roll back data set upon the occurrence of a trigger event.

7. The method in accordance with claim 6, wherein the trigger event includes expiration of a periodic timer.

8. The method in accordance with claim 6, wherein the trigger event includes a change in configuration of the EGM.

9. The method in accordance with claim 6, wherein the trigger event includes the download of the second OS to the EGM.

10. The method in accordance with claim 1, wherein storing the collected roll back data set includes verifying and signing the collected roll back data set.

11. The method in accordance with claim 1, wherein the nonvolatile sources include an EGM backplane EPROM, an EGM NVRAM, and an EGM hard drive.

12. The method in accordance with claim 1, wherein the machine configuration data includes one or more of denomination configuration data, coin limit data, bill validator values, ticket printer data, external protocol data, game configuration data, system configuration data, image data, and lifetime meter data.

13. An electronic gaming machine (EGM) that is configured to automatically change from using a first operating system (OS) to using a second OS, the EGM comprising:
one or more nonvolatile data sources associated with the EGM;
a network interface from the EGM to an OS server; and
a processor associated with computer-executable instructions that cause:
collection of a roll back data set from the one or more nonvolatile data sources;
storing of the collected roll back data set in a nonvolatile memory location associated with the EGM;
downloading the second OS to the EGM from the OS server;
initiating installation of the second OS, determining to roll the EGM back to the first OS; and
automatically reverting the EGM to run the first OS based on the roll back data set, the roll back data set including machine configuration data and one or more data structures associated with the first OS.

14. The EGM in accordance with claim 13, wherein determining to roll the EGM back to the first OS includes one of detecting an error during installation of the second OS and receiving a request to roll the EGM back to the first OS.

15. The EGM in accordance with claim 13, wherein automatically collecting the roll back data set comprises collecting the roll back data set upon the occurrence of a trigger event, wherein the trigger event includes one or more of expiration of a periodic timer, a change in configuration of the EGM, and a request to install the second OS to the EGM.

16. The EGM in accordance with claim 13, wherein storing the collected roll back data set includes verifying and signing the collected roll back data set.

17. A method of installing a configuration on a first electronic gaming machine (EGM) having existing configuration data, the method comprising:
receiving at the first EGM from a second EGM, a roll back data set comprising one or more data structures associated with an operating system (OS) run by the second EGM; and
automatically reconfiguring the first EGM in accordance with the roll back data set from the second EGM.

18. The method in accordance with claim 17, wherein the configuration data of the second EGM includes machine configuration data and game configuration data.

19. The method in accordance with claim 17, wherein the roll back data set is accompanied by instructions to change the operating system (OS) used by the first EGM to that used by the second EGM. The method in accordance with claim 18, wherein the configuration data of the second EGM includes one or more of denomination configuration data, coin limit data, bill validator values, ticket printer data, external protocol data, game configuration data, system configuration data, image data, and lifetime meter data.
